(19) United States
(12) Patent Application Publication
(10) Pub. No.: US 2006/0279629 A1
(43) Pub. Date: Dec. 14, 2006

(54) Remote video link speed enforcement

(76) Inventors: Steven F. Hocker, Olathe, KS (US); Robert C. Godsy, Chanute, KS (US)

Correspondence Address: CHASE LAW FIRM L.C, 4400 COLLEGE BOULEVARD, SUITE 130, OVERLAND PARK, KS, 66211, US

(21) Appl. No.: 11/150,402

(22) Filed: Jun. 10, 2005

(51) Int. Cl. H04N 7/18; H04N 9/47

(52) U.S. Cl. 348/143

(57) ABSTRACT

A method is disclosed for enforcing a speed limit in a zone of a roadway, such as a construction zone, where the ability of an officer to stop a speeding vehicle may be limited. A Doppler traffic radar unit and a video camera are set up at an off-road surveillance site typically adjacent the zone, and aimed at a common target area in the zone through which vehicles will sequentially pass. The speed information, Doppler audio and video are transmitted from the surveillance site to a more distant off-road location (remote site) that is accessible from the roadway, where a patrol car is located. The patrol car at the remote site receives the transmission and is equipped with an in-car video/audio system having a video buffer and a record mode. When the officer witnesses a speeding target vehicle on the video screen and hears the corresponding Doppler tone, the officer activates the video/audio system to the record mode to provide a video record of the violation including the period prior to activation stored in the history buffer. The officer may then apprehend the violator after the target vehicle leaves the restricted zone.

### FIELD OF THE INVENTION

This invention relates to a method of enforcing a speed limit in a construction zone or a school zone or at other sites where streets or roadways limit the ability of an officer to stop an offender immediately after an infraction is observed.

### BACKGROUND OF THE INVENTION

In normal speed enforcement operations, an officer observes the speed violation, enters the roadway behind the offending vehicle, activates the emergency lights and siren on the patrol vehicle and overtakes and stops the suspected vehicle and driver. The officer may then interview the driver and write a citation for speeding. In some situations, however, officers cannot perform their duties in the manner just described due to road construction, a school zone, narrow roadways without adequate shoulders or other conditions that preclude overtaking the suspected vehicle and stopping by the side of the road.

In a construction zone along a divided highway, for example, roadways may be narrowed to one lane in each direction instead of the usual two or more lanes in each direction. Speed limits in construction zones are reduced because of the increased traffic flow and, most importantly, for the safety of roadway construction workers. Unfortunately, however, enforcement is difficult due to the reduced lane width. A high number of construction accidents and unfortunate deaths of highway and roadway construction workers occur.

Due to the layout of the roadways, it is impossible in most situations to stop a vehicle for speeding in a construction zone area. Barriers are typically placed between each lane to prevent accidents between vehicles traveling in opposite directions, thus leaving one narrow lane for each direction of traffic. This typically prevents an officer from making contact with any offending driver until both the offender and the officer are out of the construction zone. Also, because of undesirable visual presence and density of traffic, it is difficult for officers to be present adjacent these barriers to make speed readings with either a radar or a laser based speed measurement device. Furthermore, for safety an officer should be away from the traffic flow and not attempt any contact on the roadway. As a practical matter, therefore, traffic violations in such zones often go undetected and the hazard for roadway construction workers remains high.

### BRIEF DESCRIPTION OF THE INVENTION

In an embodiment of the present invention, the aforementioned problem is addressed by providing a method of enforcing a speed limit in a zone of a roadway where the ability of an officer to stop a speeding vehicle may be limited. In accordance with an embodiment of the present invention, a Doppler traffic radar unit and a video camera are set up at an off-road surveillance site typically adjacent the zone, and aimed at a common target area in the zone through which vehicles will sequentially pass. The speed information, Doppler audio and video are transmitted from the surveillance site to a more distant off-road location that is accessible from the roadway, referred to herein as a “remote site,” where a patrol car is located. The patrol car at the remote site receives the transmission and is equipped with an in-car video/audio system having a video buffer and a record mode. When the officer witnesses a speeding target vehicle on the video screen and hears the corresponding Doppler tone, the officer activates the video/audio system to the record mode to provide a video record of the violation including the period prior to activation stored in the history buffer. The officer may then apprehend the violator after the target vehicle leaves the restricted zone.

Other advantages of this invention will become apparent from the following description taken in connection with the accompanying drawings, wherein is set forth by way of illustration an example, an embodiment of the present invention.

### BRIEF DESCRIPTION OF THE DRAWINGS

FIG. 1 is a block diagram showing the components of the system utilized in the practice of the enforcement method of the present invention.

FIG. 2 is a schematic illustration of a roadway illustrating a construction zone, the surveillance and remote sites, and a target vehicle.

### DETAILED DESCRIPTION

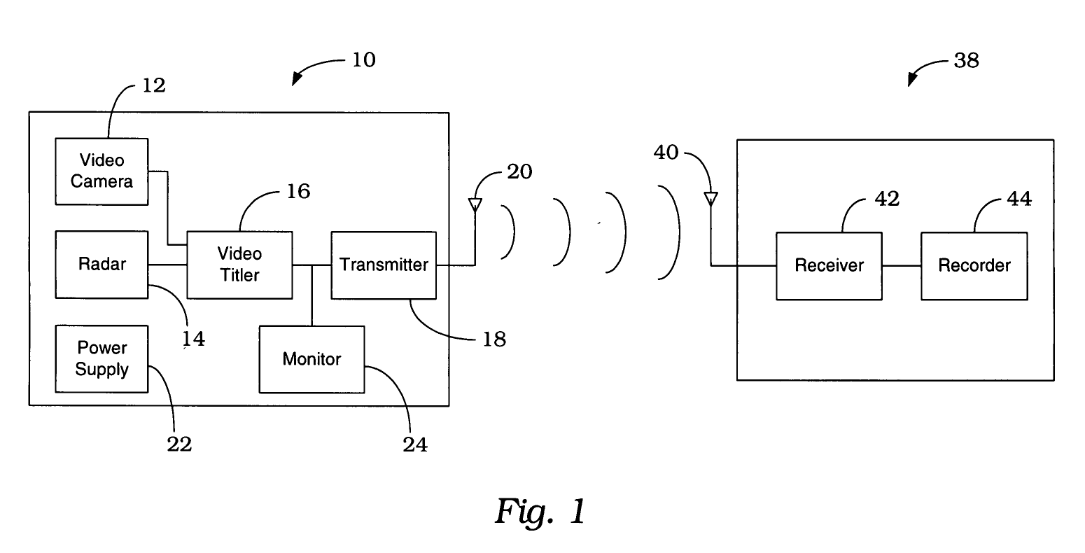

Referring to the block diagram of FIG. 1, a radar and video system 10 comprises a video camera 12, a traffic radar unit 14, a video titler 16, and a wireless video/audio transmitter 18 that feeds an antenna 20. All of the components of system 10 may be housed in a speed enforcement trailer provided with internal batteries 22 or a power supply, or system 10 may be contained in a weather resistant housing mounted on a temporary or permanent structure, a pole, or within a specially equipped police vehicle. A color video monitor 24 is connected to the output of the titler 16 and is used in the setup of the system 10 to assist in the adjustment of the video camera 12, as will be discussed below.

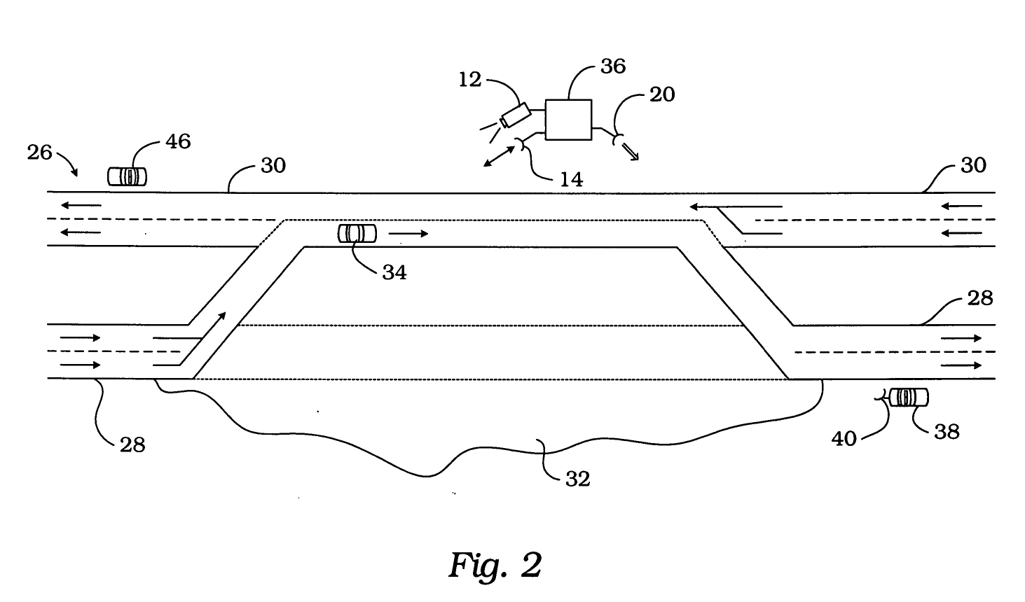

Referring to FIG. 2, an example of a traffic enforcement problem addressed by the present invention is illustrated. A divided highway 26 has an eastbound lane 28 and a westbound lane 30 as viewed in FIG. 2. Lane 28 is under repair as illustrated by the construction zone 32 and thus is discontinuous throughout construction zone 32, thereby requiring lane 30 to carry two-way traffic. Typically, speed limits are reduced throughout lane 30 through the construction zone and are especially watched by the highway patrol in order to ensure that the section of lane 30, now carrying two-way traffic due to construction zone 32, may be safely traveled by vehicles. As discussed in the background of this specification, reduced speed limits are important for the safety of roadway construction workers as well as motorists in the two-way section through the construction zone 32.

A vehicle 34 is shown traveling eastbound through the construction zone 32 and is illustrated at a location on the roadway near an off-road surveillance site 36 at which the trailer or other weather resistant housing is located. Further down the roadway ahead of vehicle 34, the surveillance site 36 is chosen by law enforcement for the purpose of aiming the video camera 12 at a target area in the construction zone 32 through which vehicles will sequentially pass, as represented by the position of the vehicle 34. Likewise, the traffic radar 14 is diagrammatically represented in FIG. 2 as aimed at vehicle 34.

Referring again to FIG. 1, a patrol vehicle is functionally illustrated at 38 and includes a receiving antenna 40, a wireless receiver 42 and an in-car video/audio system 44. As will be discussed below, the system 44 has a video buffer and is activated to a record mode by a law enforcement officer in the vehicle when a speeding incident is observed on the video screen. The patrol vehicle 38 is purposely located at an off-road remote site as illustrated in FIG. 2, i.e., a site distant from the surveillance site 36, adjacent the four-lane roadway clear of the construction zone, and with access to the eastbound lane 28 in the present example. Alternatively, the remote site could be at a location 46, for example, when it is desired to monitor westbound traffic.

In operation, referring first to the radar/video system 10 at the surveillance site 36, the directional radar 14 is preferably a DSP traffic radar that delivers vehicle speed information and corresponding Doppler audio to the titler 16. An example of a traffic radar with digital signal processing is set forth in the Henderson et al U.S. Pat. No. 5,528,246, owned by the assignee herein. A miniature video camera of the type used in in-car police video systems may comprise the video camera 12. The video titler 16 combines the outputs from the camera 12 and radar 14 to provide a composite signal that is fed to both the color video monitor 24 and the transmitter 18. The composite video includes the video image seen by the camera and superimposed information provided by the radar 14, including target speed and time and date information as disclosed, for example, in the Squicciarini et al U.S. Pat. No. 5,677,979. Accordingly, the composite signal including the speed and informational overlay is viewed on the monitor 24. This allows an officer at the surveillance site 36 to aim the video camera 12, verify that the zoom level of the camera is adequate to identify the make and model of a vehicle, e.g., vehicle 34 in FIG. 2, and confirm that the radar 14 is operational.

In addition, to commence an enforcement action in a construction or other reduced speed zone, the officer would verify the operation of the radar unit 14 using normal and accepted testing methods, including internal tests, lamp tests and external use of tuning forks as required. Once the radar unit 14 has been tested and found to be operational and accurate, the officer would then proceed to set up and verify the aim of the video camera 12 and would assure that zoom and lens settings are adequate to observe oncoming vehicles and distinguish the vehicle shape, make, model and color. The composite signal is then input to the wireless transmitter 18 as modulation on a 2.4 GHz carrier. It should be understood that the carrier frequency may be in the 2.4 to 2.483 GHz range, or other licensed or allowable frequency.

Now referring to the remote site where the patrol car 38 is located, the RF signal from antenna 20 is received at the antenna 40 on the patrol car and demodulated by the receiver 42, thereby retrieving the composite video signal. This signal is fed to the video/audio system 44 and viewed by the officer. System 44, for example, may comprise a Digital Eyewitness® in-car video system manufactured by Kustom Signals, Inc. of Lenexa, Kans., assignee herein. This system has a video buffer that records all video from the receiver 42 to digital memory, thereby providing automatic pre-event recording of video (typically three minutes) before the recorder is activated.

Accordingly, once the officer in the patrol vehicle 38 has witnessed a speed violation by observing the video screen, the officer activates the system to the record mode to obtain a video record of the incident, preceded by events from the video buffer prior to the record mode in order to provide a complete video record of the incident and its history. Therefore, the officer has seen the offender on the video screen, recorded the incident and its history, recorded the speed indicated by the traffic radar which appears as an overlay typically at the bottom margin of the video picture, and heard the Doppler tone associated with the indicated speed to confirm the accuracy of the radar. The officer may then wait for the offending vehicle to approach the patrol vehicle 38 parked at the remote site out of the reduced speed zone, and then enter the continuing eastbound lane 28 in FIG. 2 and effect a traffic stop using the overhead lights and siren in the usual manner. Using the method of the present invention, the officer writes a speeding citation based upon visual observation of that vehicle passing through the target area as captured by the video camera from the surveillance site, visual observation of the vehicle speed displayed which was obtained from the certified radar unit at the surveillance site, and hearing the audio Doppler tone from the radar unit recorded on the audio track of the video/audio recording. Accordingly, the officer can identify the speeding vehicle and legally substantiate the speed of the offender.

It is to be understood that while certain forms of an embodiment of this invention have been illustrated and described, it is not limited thereto except insofar as such limitations are included in the following claims.

Having thus described the invention, what is claimed as new and desired to be secured by Letters Patent is as follows:

1. A method of enforcing a speed limit in a zone of a roadway where the ability of an officer to stop a speeding vehicle may be limited, said method comprising the steps of:
(a) at an off-road surveillance site, providing a traffic radar unit responsive to traffic at a target area in said zone and having a speed information output corresponding to the speed of a target vehicle and a Doppler audio output corresponding to said target vehicle speed,
(b) providing a video camera at said site having a video output, and aiming said camera at said target area,
(c) transmitting said speed information output, Doppler audio output and video output to a remote site away from said zone,
(d) providing a video/audio system at said remote site having a video buffer and a record mode,
(e) receiving the transmitted speed, Doppler and video outputs at the remote site and inputting said outputs to said video/audio system so that a speeding incident may be seen and heard by a law enforcement officer, and
(f) upon the witnessing of a speed violation on said video/audio system, activating said video/audio system to said record mode to provide a video record of the violation.

2. A method of enforcing a speed limit in a zone of a roadway where the ability of an officer to stop a speeding vehicle may be limited, said method comprising the steps of:
(a) at an off-road surveillance site, providing a traffic radar unit responsive to traffic at a target area in said zone and having a speed information output corresponding to the speed of a target vehicle and a Doppler audio output corresponding to said target vehicle speed,
(b) providing a video camera at said site having a video output, and aiming said camera at said target area,
(c) transmitting said speed information output, Doppler audio output and video output via a wireless path to a remote site away from said zone from which said roadway is accessible,
(d) providing a law enforcement vehicle at said remote site with an in-car video/audio system having a video buffer and a record mode,
(e) receiving the transmitted speed, Doppler and video outputs at the remote site and inputting said outputs to said video/audio system so that a speeding incident may be seen and heard by a law enforcement officer, and
(f) upon the witnessing of a speed violation on said video/audio system, activating said video/audio system to said record mode to provide a video record of the violation.

3. A method of enforcing a speed limit in a zone of a roadway where the ability of an officer to stop a speeding vehicle may be limited, said method comprising the steps of:
(a) at an off-road surveillance site, providing a traffic radar unit responsive to traffic at a target area in said zone and having a speed information output corresponding to the speed of a target vehicle and a Doppler audio output corresponding to said target vehicle speed,
(b) providing a video camera at said site having a video output, and aiming said camera at said target area,
(c) transmitting said speed information output, Doppler audio output and video output via a wireless path to a remote site away from said zone from which said roadway is accessible,
(d) providing a law enforcement vehicle at said remote site with an in-car video/audio system having a video buffer and a record mode,
(e) providing said law enforcement vehicle with a receiver responsive to the transmitted speed, Doppler and video outputs, and converting said outputs to composite video which is input to said video/audio system so that a speeding incident may be seen and heard by a law enforcement officer, and
(f) upon the witnessing of a speed violation on said video/audio system, activating said video/audio system to said record mode to provide a video record of the violation.
